(19) United States
(12) Patent Application Publication
(10) Pub. No.: US 2007/0014008 A1
(43) Pub. Date: Jan. 18, 2007

(54) Birefringent beam displacer

(75) Inventor: Chandler James Kennedy, Town & Country, MO (US)

Correspondence Address: Daniel J. Burnham;JENKENS & GILCHRIST, A PROFESSIONAL CORPORATION, 225 W. Washington, Ste. 2600, Chicago, IL, 60606-3418, US

(73) Assignee: NORTHROP GRUMMAN CORPORATION

(21) Appl. No.: 11/183,676

(22) Filed: Jul. 18, 2005

(51) Int. Cl. G02B 27/28

(52) U.S. Cl. 359/495; 359/483

(57) ABSTRACT

A birefringent beam displacer assembly includes a light source that produces a polarized initial light beam having a first portion and a second portion. A halfwave plate changes a polarity of the first portion of the polarized initial light beam. A birefringent beam displacer receives, at an input side, the first portion from the halfwave plate and the second portion. The birefringent beam displacer has an optic axis for producing a vector walkoff of the second portion. The first portion of the polarized initial light beam passing substantially parallel to the length of the birefringent beam displacer, and the second portion moves at an angle toward the first portion such that the first portion and the second portion substantially overlap at an output side of the birefringent beam displacer to form a combined beam.

### FIELD OF THE INVENTION

The present invention relates generally to laser diodes and, in particular, to birefringent beam displacer to combine two halves of a beam with opposite polarization into a single beam with half the height of the input beam and twice the intensity.

### BACKGROUND OF THE INVENTION

Semiconductor laser diodes have numerous advantages. They are small and the widths of their active regions are typically a submicron to a few microns and their heights are usually no more than a fraction of a millimeter. The length of their active regions is typically less than about a millimeter. The internal reflective surfaces, which produce emission in one direction, are formed by cleaving the substrate from which the laser diodes are produced and, thus, have high mechanical stability.

High efficiencies are possible with semiconductor laser diodes with some pulsed junction laser diodes having external quantum efficiencies near 50%. Semiconductor laser diodes produce radiation at wavelengths from about 20 to about 0.7 microns depending on the semiconductor alloy that is used. For example, laser diodes made of gallium arsenide with aluminum doping (AlGaAs) emit radiation at approximately 0.8 microns (˜800 nm) which is near the absorption spectrum of common solid state laser rods and slabs made from Neodymium-doped, Yttrum-Aluminum Garnet (Nd:YAG), and other crystals and glasses. Thus, semiconductor laser diodes can be used as the optical pumping source for larger, solid state laser systems.

For some applications involving semiconductor laser diodes, it is desirable to combine light beams generated from the laser diodes into a single light beam having a greater intensity than either light beam alone. Prior systems for doing this are complex, relatively expensive and bulky. For example, a beam rotator can be used to combine the two beams. However, beam rotators are relatively large and typically have an axial length of at least 12 mm.

Other systems require the beams to enter a birefringent prism along different paths. Each of the paths is at an angle to the surface of the birefringent prism. Additional systems require use of a controllable liquid crystal cell to selectively rotate the polarization of the incoming light beams. However, such systems are bulky and complex. The present invention is directed to satisfying this and other needs.

### SUMMARY OF THE INVENTION

The present invention is directed to a birefringent beam displacer assembly. A light source produces a polarized initial light beam having a first portion and a second portion. A halfwave plate changes a polarity of the first portion of the polarized initial light beam. A birefringent beam displacer receives, at an input side, the first portion from the halfwave plate and the second portion. The birefringent beam displacer has an optic axis for producing a vector walkoff of the second portion. The first portion of the polarized initial light beam passes substantially parallel to the length of the birefringent beam displacer, and the second portion moves at an angle toward the first portion such that the first portion and the second portion substantially overlap at an output side of the birefringent beam displacer to form a combined beam.

The present invention is further directed to a birefringent beam displacer assembly. A light source produces a generally rectangular polarized initial light beam having a first portion and a second portion. A halfwave plate changes a polarity of the first portion of the rectangular polarized initial light beam. A birefringent beam displacer receives, at an input side, the first portion from the halfwave plate and the second portion. The birefringent beam displacer has an optic axis for producing a vector walkoff of the second portion. The first portion of the rectangular polarized initial light beam passes substantially parallel to the length of the birefringent beam displacer, and the second portion moves at an angle toward the first portion. The birefringent beam displacer has a predetermined length such that the first portion and the second portion substantially overlap at an output side of the birefringent beam displacer to form a generally rectangular combined beam.

The present invention is further directed to a method for increasing an intensity of a light beam. A collimated light beam having a first portion and a second portion is developed. A polarity of the first portion of the collimated light beam is changed. The first portion, after the changing, and the second portion are passed through a birefringent beam displacer. The birefringent beam displacer causes the second portion of the collimated light beam to move toward and overlap with the first portion at an output side of the birefringent beam displacer.

The above summary of the present invention is not intended to represent each embodiment or every aspect of the present invention. The detailed description and Figures will describe many of the embodiments and aspects of the present invention.

### BRIEF DESCRIPTION OF THE DRAWINGS

The foregoing and other advantages of the invention will become apparent upon reading the following detailed description and upon reference to the drawings.

FIG. 1 is an end view of one type of laser diode package that may be used with the present invention;

FIG. 2 is a perspective view of the laser diode package of FIG. 1;

FIG. 3 illustrates a top view of a laser diode array having four laser diodes according to an embodiment of the invention;

FIGS. 4A and 4B schematically illustrate electric fields for beams of light that are polarized in different directions; and

FIG. 5 illustrates a birefringent beam displacer according to an embodiment of the invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF ILLUSTRATIVE EMBODIMENTS

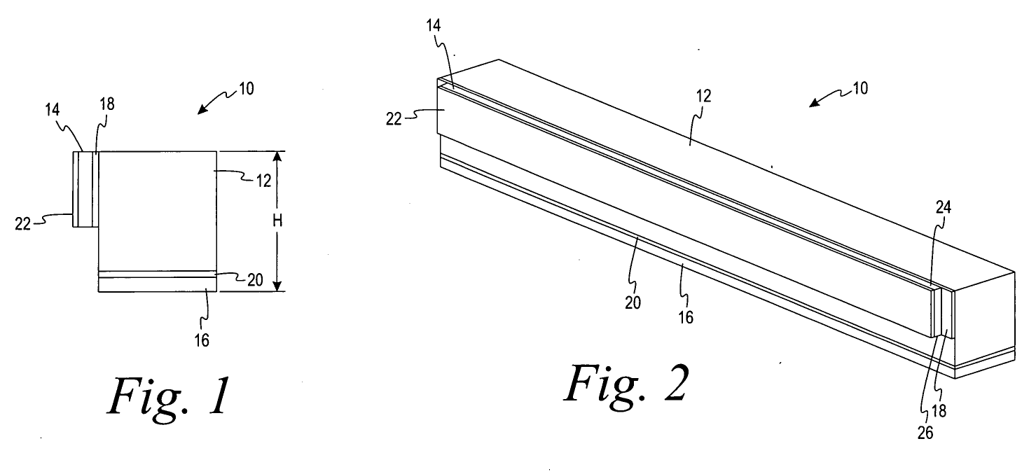

Referring initially to FIGS. 1 and 2, a laser diode package 10 includes a heat sink 12, a laser diode bar 14, and a lower substrate 16. The laser diode package 10 may be the laser diode package 10 disclosed in U.S. Pat. No. 6,636,538, entitled “Laser Diode Packaging,” which is commonly assigned, and the disclosure of which is incorporated by reference herein. The laser diode bar 14 is attached to the heat sink 12 through a first solder layer 18. A non-conductive substrate 16 is attached to the heat sink 12 through a second solder layer 20. The laser diode bar 14 may also include a bar solder layer 22 on its side which opposes the heat sink 12.

The laser diode bar 14 has an emitting surface 24 at its upper end and a reflective surface 26 that opposes the emitting surface 24. The height of the laser diode bar 14 is defined as the distance between the emitting surface 24 and reflective surface 26. The junction of the laser diode 14, which is the region at which the photons are emitted from the laser diode bar 14, is typically closer to the heat sink 12. However, the junction of the laser diode bar 14 can be closer to the exposed end of the laser diode bar 14 on which the solder layer 22 is placed. Electrical power is guided to defined regions of the junctions by providing electrically conductive material within the laser diode bar 14 adjacent those emitting regions and less electrically conductive material outside those regions. Thus, the laser diode bar 14 has a multitude of emission points on the emitting surface 24 corresponding to those regions where electrical energy is converted into optical energy. When the electrical power is applied to the laser diode package 10, the photons propagate through the junction, are reflected off the reflective surface 26, and consequently emit only from the emitting surface 24 in a direction perpendicular to it.

The heat sink 12 of the laser diode package 10 is made of a material that is both electrically and thermally conductive, such as copper. Electrical conductivity is required to conduct the electrical current through the laser diode bar 14 to produce the optical energy. Thermal conductivity is needed to conduct the intense heat away from the laser diode bar 14 and maintain the laser diode bar 14 at a reasonable operating temperature.

The substrate 16 serves the function of electrically isolating the current-conducting heat sink 12 from the ultimate heat sink, which is typically a metallic heat exchanger. The substrate 16 can be a variety of materials that are electrically insulative. The substrate 16 made of an electrically insulative material must have a metalization layer if its surface is to be soldered.

The laser diode package 10 may be combined with other laser diode packages 10 to form a laser diode array. The laser diode array may include, e.g., four laser diode packages 10 laying parallel to each other. While the laser diode package 10 disclosed in U.S. Pat. No. 6,636,538 has been illustrated, the present invention can be used with many other types of laser diode packages and laser diode arrays, such as those disclosed in U.S. Pat. Nos. 5,985,684 and 6,310,900, which are commonly assigned, and the disclosures of which are hereby incorporated by reference in their entireties.

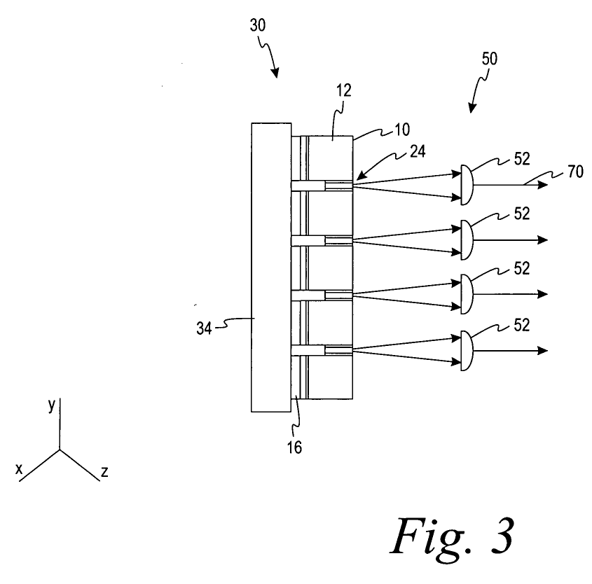

FIG. 3 illustrates a top view of a laser diode array 30 having four laser diode packages 10 according to an embodiment of the invention. A lens assembly 50 includes a plurality of lenses 52, one of the lenses 52 corresponding to the emitting surface of each laser diode package 10 of the laser diode array 30. As illustrated, each of the lenses 52 include a flat surface located opposite a scalloped surface. As shown, the scallops on the scalloped surface have a convex curvature. Light from the emitting surfaces 24 of the laser diodes 10 is typically emitted at known angles to the emitting surfaces 24. The lenses 52 of the lens assembly 50 serve to collimate the light. The light emitted from the laser diodes 12 passes through the lenses 52 of the lens assembly 50, which reduces the divergence of the light beam, altering the direction of some of the rays of light. The light beam is collimating such that the rays of the light beam out of the lenses 52 of the lens assembly 50 are substantially parallel to each other. The collimated light beam 70 may have, e.g., a width of 5 mm in the y-axis direction, as shown in FIG. 3. The collimated light beam 70 may have a z-axis dimension (into the paper) of 2.5 mm. Thus, the collimated light beam 70 has a generally rectangular cross-sectional profile.

In other embodiments, additional or fewer than four lenses 52 may be utilized to generate the collimated light beam 70. Also, other embodiments may use a laser array 30 with more or fewer than four laser diode packages 10. Some embodiments may, in fact, use a single laser diode package 10.

Light is an electromagnetic wave having an electric field. The collimated beam of light in FIG. 3 is a transverse wave that may be linearly polarized, i.e., its direction of vibration may always occur along one direction. The lens assembly in FIG. 3 may include various polarizers to ensure that the collimated beam of light of the cylindrical lens 55 is linearly polarized.

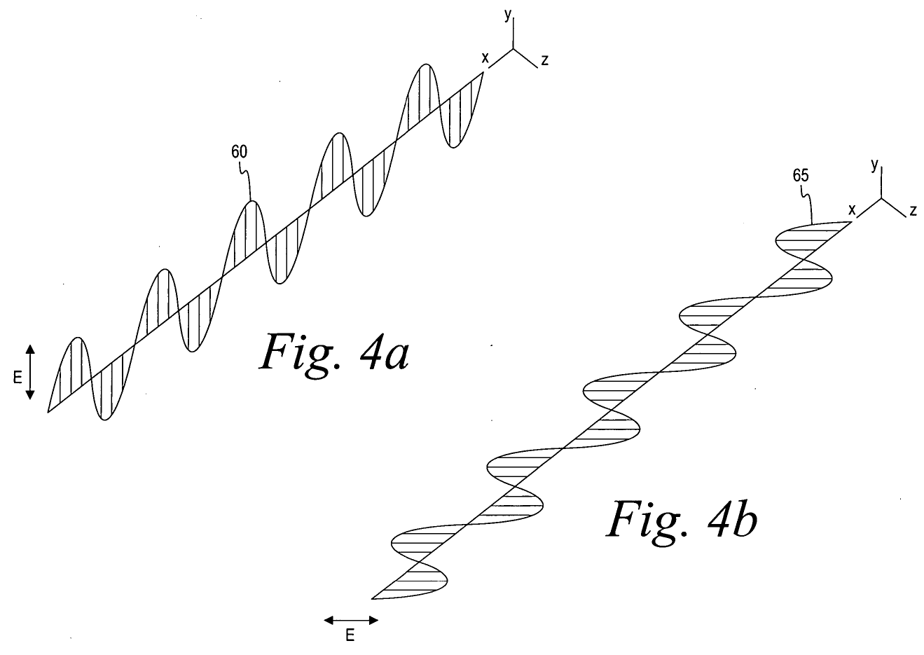

FIGS. 4A and 4B illustrate electric fields 60 and 65 for beams of light that are polarized in different directions. FIG. 4A shows the electric field 60 that is polarized in the y-axis direction. Accordingly, the electric field 60 oscillates in the upward and downward direction about the x-axis. The direction of the electric fields 60 and 65 is denoted with the reference “E” in FIGS. 4A and 4B. FIG. 4B shows an electric field 65 that is polarized in the z-axis direction. The electric field 65 oscillates from left to right about the x-axis. Accordingly, as illustrated, electric field 60 is rotated 90° from electric field 65.

Referring again to FIG. 3, the collimated beam 70 exiting from the lenses 52 of the lens assembly 50 may, for example, have an electric field that is in the y-axis direction, like the electric field 60 of FIG. 4A. The collimated beam 70 passes through a beam displacer that serves to reduce its height by half and increases its intensity by a factor of almost two, as discussed below.

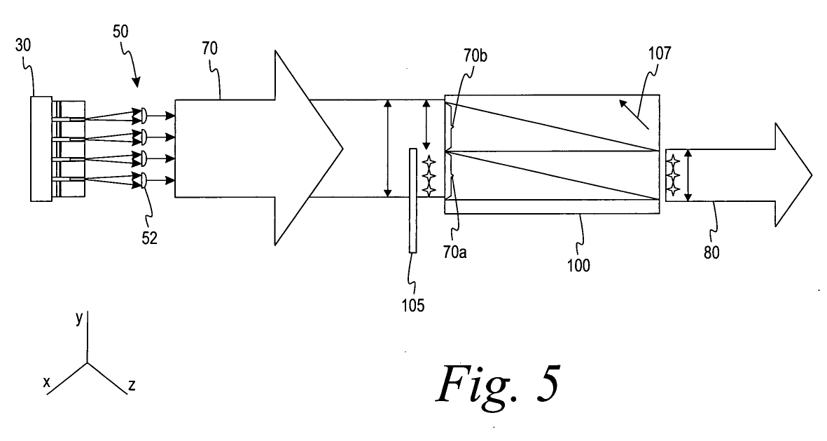

FIG. 5 illustrates a birefringent beam displacer 100 according to one embodiment of the invention. The birefringent beam displacer 100 may have a length of 25 mm in the x-direction. The birefringent beam displacer 100 may have a height of 6 mm in the y-direction and a depth of 3 mm in the z-direction to accommodate the collimated light beam 70. The beam displacer 100 may be a beam displacer manufactured by, e.g., Conex, headquartered in Pleasanton, Calif., or Karl Lambrecht, headquartered in Chicago, Ill.

The collimated beam 70 from the lens assembly 50 is directed toward the beam displacer 100. As shown, the collimated beam 70 may be generated from the laser diode array 30 and lens assembly discussed above with respect to FIGS. 1-4. The collimated beam 70 may have a height of 5 mm in the y-direction and a depth (into the paper in the z-direction) of 2.5 mm, and power of 20 Watts. The birefringent beam displacer 100 has an optic axis 107, as shown by the arrow in the upper right-hand corner of the birefringent beam displacer 100. The optic axis 107 of the birefringent beam displacer 100 of FIG. 5 is 45° in the plane of the x and y axes.

The birefringent beam displacer 100 is formed of a birefringent material such as, e.g., yttrium vanadate, calcite, or rutile, each of which are synthetically developed optical materials. The birefringent beam displacer 100 may be coated with anti-reflection coating to minimize the amount of energy lost by the light beam while inside the birefringent beam displacer 100. Birefringent materials have optical properties such that the speed of light passing through them is dependent upon their directions of polarization. That is, the refractive index of birefringent materials is dependent upon the direction of the light beam's polarization.

A light beam that has an electric field completely perpendicular to the optic axis 107 is called an ordinary wave, or o-wave. A light beam having an electric field that is in the plane of the optic axis is called an extraordinary wave, or e-wave.

The collimated light beam 70 shown to the left of the beam displacer 100 is an e-wave (i.e., its polarization is within the plane of page in the y-axis direction). The bottom half 70a of the collimated light beam 70 passes through a halfwave plate 105 linearly polarized at 45°. The halfwave plate 105 may be formed of crystal quartz. The halfwave plate 105 serves to shift the polarization of the bottom half of the collimated light beam 70 by 90°. In other embodiments, devices or objects other than the halfwave plate may be utilized to shift the polarization of the bottom half of the collimated light beam 70. Accordingly, after passing through the halfwave plate 105, the bottom half 70a of the collimated light beam 70 has an electric field in the z-direction (i.e., coming out of the paper). Therefore, the bottom half 70a of the collimated light beam 70 is now an o-wave because it is polarized in a direction perpendicular to the optic axis 107 of the birefringent beam displacer 100. The direction is designated by the illustrated stars, which signify that its electric field is up and down into the paper in the z-direction.

The o-wave (i.e., the bottom half 70b of the collimated light beam 70) passes straight through the bifrefringent beam displacer 100 on a path parallel with the x-axis as shown in FIG. 5. The e-wave (i.e., the top half 70a of the collimated light beam 70), on the other hand, does not pass straight through the beam displacer 100. Instead, because its polarization is in the plane of the optic axis 107, its power propagates at a slight angle downward from the direction of the input beam. The width of the e-wave is substantially constant, but its direction is at an angle down toward the bottom of the birefringent beam displacer 100. Once the e-wave reaches the opposite edge of the birefringent beam displacer 100, it exits the birefringent beam displacer 100 at a direction perpendicular to the edge (i.e., it stops moving in a downward direction). The change in direction of the e-wave is known as a Poynting vector walkoff. The angle of the walkoff may be, e.g., about 4°. The angle of the walk-off dictates the overall length of the beam displacer 100. Each type of beam displacer 100 has an inherent walk-off angle that is a function of its optical properties.

The e-wave 70b experiences a walkoff such that when the e-wave exits the birefringent beam displacer 100, it is overlapping the o-wave 70a. The length of the birefringent beam displacer 100 is designed so that there is ideally 100% overlap between the o-wave and the e-wave, although in practical operation, an overlap of greater than 95% is acceptable. Accordingly, an output beam 80 exiting the birefringent beam displacer 100 is the sum of the o-wave (70a) and the e-wave (70b) that entered the birefringent beam displacer 100 on its other side. The height of the exiting combined beam 80 is ideally 2.5 mm, half of the height of the collimated light beam 70. The intensity of the exiting combined beam 80 is roughly twice that of the input collimated light beam 70. The combined beam 80 has an electric field polarized in both the y-axis and z-axis directions. The o-wave 70a, and e-wave 70-b, and the combined beam 80 all have about the same cross-sectional area.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

What is claimed is:

1. A birefringent beam displacer assembly, comprising:
a light source for producing a polarized initial light beam having a first portion and a second portion;
a halfwave plate to change a polarity of the first portion of the polarized initial light beam; and
a birefringent beam displacer for receiving at an input side the first portion from the halfwave plate and the second portion, the birefringent beam displacer having an optic axis for producing a vector walkoff of the second portion, the first portion of the polarized initial light beam passing substantially parallel to the length of the birefringent beam displacer, and the second portion moving at an angle toward the first portion such that the first portion and the second portion substantially overlap at an output side of the birefringent beam displacer to form a combined beam.

2. The birefringent beam displacer assembly according to claim 1, wherein the light source is a laser diode assembly.

3. The birefringent beam displacer assembly according to claim 1, further including a lens assembly to collimate the initial light beam produced by the light source.

4. The birefringent beam displacer assembly according to claim 3, wherein the collimated initial light beam has a polarity parallel to the optic axis.

5. The birefringent beam displacer assembly according to claim 1, wherein the first portion has a polarity perpendicular to the optic axis after exiting the halfwave plate.

6. The birefringent beam displacer assembly according to claim 1, wherein the first portion, the second portion, and the combined beam have about the same cross-sectional area.

7. The birefringent beam displacer assembly according to claim 1, wherein the combined beam has an intensity about twice an initial intensity of the polarized initial light beam.

8. The birefringent beam displacer assembly according to claim 1, wherein the birefringent beam displacer is formed of a material selected from the group consisting of: yttrium vanadate, calcite, and rutile.

9. The birefringent beam displacer assembly according to claim 1, wherein the angle is about 4°.

10. A birefringent beam displacer assembly, comprising:
a light source for producing a rectangular polarized initial light beam having a first portion and a second portion;
a halfwave plate to change a polarity of the first portion of the rectangular polarized initial light beam; and
a birefringent beam displacer for receiving at an input side the first portion from the halfwave plate and the second portion, the birefringent beam displacer having an optic axis for producing a vector walkoff of the second portion, the first portion of the rectangular polarized initial light beam passing substantially parallel to the length of the birefringent beam displacer, the second portion moving at an angle toward the first portion, the birefringent beam displacer having a predetermined length such that the first portion and the second portion substantially overlap at an output side of the birefringent beam displacer to form a generally rectangular combined beam.

11. The birefringent beam displacer assembly according to claim 10, wherein the first portion, the second portion, and the rectangular combined beam have about the same cross-sectional area.

12. The birefringent beam displacer assembly according to claim 10, wherein the rectangular combined beam has an intensity about twice an initial intensity of the rectangular polarized initial light beam.

13. The birefringent beam displacer assembly according to claim 10, wherein the birefringent beam displacer subjects the second portion to a walkoff angle of about 4°.

14. A method for increasing an intensity of a light beam, comprising:
developing a collimated light beam, the collimated light beam having a first portion and a second portion;
changing a polarity of the first portion of the collimated light beam; and
passing through a birefringent beam displacer the first portion, after the changing, and the second portion, to cause the second portion of the collimated light beam to move toward and overlap with the first portion at an output side of the birefringent beam displacer.

15. The method according to claim 14, wherein the developing includes activating a laser diode assembly to produce an initial light beam.

16. The method according to claim 15, wherein the developing includes collimating the initial light beam produced by the laser diode array to form the collimated light beam.

17. The method according to claim 14, wherein the collimated light beam has a polarity parallel to an optic axis of the birefringent beam displacer.

18. The method according to claim 14, wherein the changing includes passing the first portion through a halfwave plate.

19. The method according to claim 14, wherein the first portion, the second portion, and the combined beam have about the same cross-sectional area.

20. The method according to claim 14, wherein the combined beam has an intensity about twice an initial intensity of the initial light beam.
